(19) United States
(12) Patent Application Publication
(10) Pub. No.: US 2004/0190737 A1
(43) Pub. Date: Sep. 30, 2004

(54) Method for recording information in a hearing device as well as a hearing device

(76) Inventors: Volker Kuhnel, Mannedorf (CH); Silvia Allegro, Oetwil am See (CH)

Correspondence Address: PEARNE & GORDON LLP, 1801 EAST 9TH STREET, SUITE 1200, CLEVELAND, OH, 44114-3108, US

(21) Appl. No.: 10/396,058

(22) Filed: Mar. 25, 2003

(51) Int. Cl. H04R 25/00

(52) U.S. Cl. 381/312; 381/314; 381/315; 381/323

(57) ABSTRACT

The present invention relates to a method for recording information in a hearing device and/or in a recording unit at least temporally operationally connected to the hearing device. The method consists in that a point in time of the recording and/or a recording frequency as well as the information to be recorded, as data and/or parameters and/or adjustments of the hearing device are adjusted freely or are programmable, respectively. Furthermore, a hearing device is described that is suitable to use the method. By the present invention, a multitude of the parameters being adjustable in a hearing device can be checked or surveyed all together or selectively in real, i.e. actually existing acoustic environments in order to optimally adjust or adapt the hearing device afterwards, that means after the analysis by the fitter, for example.

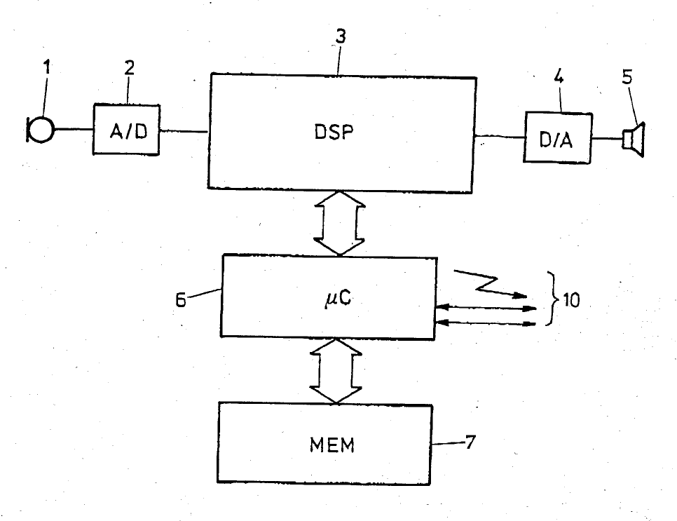

The present invention relates to a method for recording information in a hearing device or in a recording device at least partially connected to the hearing device as well as a hearing device.

Today's hearing devices are adjusted to the individual needs of hearing device users. The most important adjustment when used in the medical area lies therein that the hearing device can compensate or correct a hearing impairment of a patient. Therefore, an audiogram, for example, is established of the patient based on which audiogram different adjustments are made in the hearing device. Furthermore, today's hearing devices offer the possibility to select one of several hearing programs available in the hearing device in an automatic or manual manner. Thereby, the possibility is created for the hearing device user to adjust his hearing device to different acoustic situations in a best possible way.

The many and diverse adjustment possibilities, being either manually or automatically, give often raise, on the other hand, to confusions of the hearing device user, because it is difficult for the inexperienced hearing device user, on the one hand, to select the correct adjustments, on the other hand, an automatic selection of the hearing program can often not be comprehended by the hearing device user.

For this reason, it has already been proposed to record certain data in the hearing device, which data allow to analyze occurred acoustic situations afterwards. In this connections reference is made to U.S. Pat. No. 4,972,487, wherein a hearing device is described that has a memory unit in which the following data can be recorded:

Number of hearing program changes;

How many times a particular hearing program has been used, the selected hearing program being used for a minimal amount of time; and

How long each of the possible hearing programs has been active.

Furthermore, reference is made to U.S. Pat. No. 5,210,803. In this printing a hearing device is also described with a memory unit. Though, and in contrast to the first mentioned printing, the memory unit is being used to save certain characteristics of the hearing device based on which the hearing device can be identified unambiguously. It is pointed out that certain information is already saved during he manufacturing of the hearing device, as e.g. the manufacturing company or technical data, as e.g. the gain set.

For the sake of completeness, reference is made to a further known information recording variation, which is described in WO 00/41440. As for the above-mentioned state of the art, this known teaching is also dealing of a hearing device with a memory unit to record information during operation of the hearing device. The information being recorded is limited to register the time during which the hearing device is being used. Therewith, the possibility is created to charge the actual use of the hearing device to the user. Furthermore, it is proposed that certain characteristics of the hearing device can only be used in a limited manner, once a preset time has been reached. An elimination of such limitations can only be reached by paying a fee.

It has been shown that all the known methods to record information are not sufficient to explain the actual reason for an erroneous adjustment or for an automatic adjustment being unexpected for the hearing device user in order that the adjustment can be corrected in the following. As a result thereof, the adaptation process according to the known information recording methods is extremely lavish and time-consuming.

It is therefore the object of the present invention to provide a method for recording information in a hearing device and/or in a recording unit operationally connected at least partially to the hearing device, which method allows complete investigation of possible erroneous adjustments or of adjustments being unexpected for the hearing device user in certain situations. It is a further object of the present invention to obtain maximum support for these adjustments of a hearing device in order to simplify the adjustment or fitting process.

This object is reached by the measures given in the characterizing part of claim 1. Advantageous embodiments of the present invention are given in further claims.

The present invention has the following advantages: By freely adjusting or programming a beginning of the information recording as well as the information being recorded, such as data and/or parameters and/or adjustments of the hearing device, the adjustment of a hearing device is for the first time possible in an optimal manner to the individual desire and the individual hearing impairment of a hearing device user. Thereby, the multitude of the parameters being adjustable in a hearing device can be checked or surveyed all together or selectively in real, i.e. actually existing acoustic environments in order to optimally adjust or adapt the hearing device afterwards, that means after the analysis by the fitter, for example. Because of the multitude of the parameters being possibly adjustable, the selective recording according to the present invention is most important. Thus, it is not possible to record all possible parameters and other adjustments of a hearing device at all times and always, because there is only limited available memory space as well as available energy in the hearing device.

Even after an adjustment of the hearing device by a fitter, the actual parameter adjustments may not necessarily be sufficient in order to cope optimally with the multitude of possible situations. It is therefore decisive, as realized by the present invention, that the fitter obtains an image of the momentary acoustic surrounding situation together with other relevant information, as e.g. information regarding the occurrence of signal feedback.

In addition, known solutions do not offer the possibility to use the information recording for a hardware diagnosis of the hearing device as it is the case e.g. in connection with microphone matching, changing the microphone sensibility, etc. The fitter can, by applying the present invention, clearly improve the hearing device service and can provide any necessary adaptation significantly faster. Thereby, he can in particular use the knowledge of the hardware state of the hearing device.

It is pointed out that the present invention can not only be used for hearing devices—whether they are behind the ear, in the ear canal or implanted—for the compensation or correction of a hearing impairment. The present invention can rather be applied for any hearing aid which is used to improve communication.

The present invention will be further explained by referring to a drawing showing an exemplified embodiment. Thereby, the only figure shows a block diagram of a hearing device according to the present invention.

The only figure shows, in a schematic representation, a hearing device consisting of a microphone 1, a signal processing unit 3 and a loudspeaker unit 5, which is often called receiver, the microphone 1 as well as the loudspeaker unit 5 being operationally connected to the signal processing unit 3. In case the implementation of the signal processing in the hearing device is realized by digital technology, as it can be seen from the figure, an analog to digital converter 2 is provided between the microphone 1 and the signal processing unit 3, and a digital to analog converter 4 is provided between the signal processing unit 3 and the loudspeaker unit 5.

It is pointed out that, although only a single microphone is represented in the figure, the use of several microphones is feasible, as it is e.g. provided for the “beam former” technology. Furthermore, the present invention is in particular suitable for binaural hearing devices.

Furthermore, a control unit 6 is contained in the hearing device, which control unit 6 is operationally connected, on the one hand, to the signal processing unit 3 and, on the other hand, to a memory unit 7. In addition, a further embodiment of the present invention consists in that a communication takes place over a connecting device 10 with an external processing unit, which is arranged outside of the hearing device. The connecting unit 10 can either support a wired or also a wireless data transfer.

With the aid of the exemplified structure of a hearing device represented in the figure, a multitude of parameters and information can be recorded in the memory unit 7, the parameters and information being grouped as follows:

hardware data, i.e essentially the configuration of a hearing device;

information of the fitting history of a hearing device;

operating data or current adjustments or time signals;

statistical data.

According to the present invention, information of a single as well as information of several of the aforementioned information groups can be recorded in the memory unit 7 or in a processing unit which is external regarding the hearing device or in an external memory unit.

Hardware data being recorded can be the following e.g.:

Specification of vent, hook, microphone, receiver, tubing, shells, hearing device types and embodiments, right or left device, switch at the hearing device, manufacturing data as serial number, manufacturing date, identification features of the electronics being used, version of the (Digital Signal Processing) —DSP—firmware, version of the DSP algorithms, version of the used fitting software, version of the used data recording software, version of the control unit, maximum gain, delay over the signal feedback path, microphone matching, etc.

With the aid of the hardware data, the fitter can refine his judgment of the hearing device, which gives him the possibility to detect possible hardware damage in a short time.

By the present invention the recording of the fitting history of a hearing device has been realized for the first time. Thereby, the fitting parameters or the changes in regard to the factory set adjustment as well as the place of the fitting, the date of the fitting and the program version of the fitting software are saved. The knowledge of this information is very advantageous, because it can be taken into account in a new fitting process. As a result thereof, a new fitting is simplified and shortened and always leads to a better result. In addition, it can be used to the understanding and for documentation of the whole “patient history” or the fitting history of the hearing device, respectively, from which again conclusions to the hearing device user or his habits result. The fitter has now the possibility to follow the preferences and desires of his client over several years and to better serve each client individually.

Besides the current adjustments, which can be e.g. information on the hearing program, settings of used filters, identified momentary surrounding situations etc., the present invention also allows to record so-called operating data, which are, for example, acoustic signals itself recorded by the microphone 1, the registration of the manipulation of a switch integrated into the hearing device or the stimuli submitted to a hearing device user in the form of an acoustic signal or in the form of a direct stimuli of the inner ear, as it is the case in connection with implantable hearing devices. Naturally, a large amount of data accumulates while recording acoustic signals so that a recording of such data is only possible in external memory due to the limited memory size of the memory unit 7 provided in the hearing device at the time the invention was made. As a result thereof, the hearing device must be connected to an external memory unit over the connecting unit 10 in this case. Limitations also result for a permanent recording of a large amount of data by the limited amount of energy in a hearing device. Accordingly, energy must be supplied to the hearing device for a permanent data recording in the internal memory unit 7.

In addition, a memorization of statistical data, as e.g. the amplitude percentile, is possible. Percentiles correspond to an “amplitude” sorting of signals, and are used e.g. to differentiate situations. Percentiles or percentile generators, respectively, are described in EP-0 732 036, for example.

The advantage of data recording of statistical data lies in a reduced memory size need compared to the memorization of not processed raw data.

For all the aforementioned embodiments, the possibility exists as option to record the date and the time in the memory unit 7. In this connection, a further problem arises in that, for each interruption of the power supply, e.g. by switching off the hearing device during the night, the date as well as the time is lost. For this reason, it is proposed to transfer the current date and the current time from outside to the hearing device in regular intervals or by enquiry by the hearing device. Thereby, one or a combination of the following external synchronization units can be used:

An intelligent remote control, which is used for example to adjust certain parameters of the hearing device as e.g. gain or the like;

Computer, mobile telephones, PDA (Personal Digital Assistant) or other electronic devices by which desired information is transferred over Bluetooth, for example; and

Radio signals which contain a time signal in the long wave range (atomic clock).

The aforementioned possibilities for time synchronization result in a further possibility to implement new applications in the hearing device, which are based on the availability of date and time. One such application consists in implementing an acoustic agenda, which acoustically indicates a coming appointment to the hearing device user. One possibility lies therein to implement the agenda in the hearing device itself. In another embodiment, the relevant data are coming from an external device, e.g. a PDA, and are simply acoustically processed by the hearing device. Besides the pure appointment information from a separate agenda, it is further proposed to indicate the intake of medicine in an acoustic manner, which medicine must be taken at preset times and at preset intervals.

In a further embodiment of the present invention based on the time synchronization, it is provided to put computer programs at disposal, which process corresponding actions based on one or several of the following factors:

Given time of day;

Given dates;

Working day or given working day, respectively;

Given holiday.

For this embodiment of the present invention, the possibility consists in selecting a hearing program automatically, for example at a normal working day, which hearing program takes into account the acoustic surround situation normally predominating at the working place of the hearing device user, while processing the relevant acoustic signals in a best possible way.

The mentioned computer programs can either be implemented in the hearing device or in an external device, as for example a PDA (Personal Digital Assistant). For an implementation in the hearing device as well as in an external device, synchronization processes can be provided in a known manner to match the relevant information between the partitioning devices. Therewith, the aspect of increased data security has also been taken into account.

For visually handicapped people, the possibility opens up in a further embodiment of the present invention in addition by implementing an acoustic watch in the hearing device.

In a further embodiment it is provided that a watch is contained in the hearing device in order to measure the absolute time or in order to generate a time stamp. The further aspects of the present invention can be realized conveying the same general sense.

It is expressly pointed out that the aspect of the time synchronization is not limited to the use of data recording in or through a hearing device, but can be used independently therefrom.

As mentioned before, the selection of the data to be recorded is freely programmable. Thereby, two advantages can be obtained first:

First, only the maximum necessary number of parameters must be saved because of the limited battery and memory capacity. Second, the registration of, for example, feedback situation can require other parameters than the registration of automatic hearing program switchings. Different situations can be registered authentically by the memorization of the most important parameters. In order to reach a best possible adjustment of the hearing device, the fitter decides individually for each hearing device user, which of the parameters to be memorized represents the best combination in order to improve the next fitting process. By a corresponding programming, it is possible to change the data or parameters to be recorded during operation. So, it can be, for example, useful that, while the first hearing program is running, the gain is saved. If a switching to a second hearing program is taking place, other information, e.g. components of surrounding noise, must be recorded. A further aspect of the present invention relates to the triggering of the data or information recording, respectively, i.e. the point in time from which data or information, respectively, must be recorded.

In this connection, it is pointed out that U.S. Pat. No. 4,972,487 discloses the recording of data after a change of hearing program. But this process is fixed to the corresponding event and cannot be changed.

In this connection, the present invention is characterized in that the event relevant for the information recording is selectable freely, either be it in manual triggering, which is performed, for example, by the hearing device user himself, or be it a programmed triggering, for which different preset conditions must be met.

For manual triggering, the data recording is manually triggered by the hearing device user or by the fitter, for example by pressing a button on the remote control or on the hearing device. Thereby, the hearing device user can decide which situation is recorded in order to prove e.g. which situations cause difficulties to him and how the situations are presented to him. In order to register the complex situations as completely as possible, the duration of data recording is also freely selectable. The fitter, responsible for the fitting, is therewith no longer relying on artificial lab situations but he can directly reconstruct the behavior of the hearing device in the situations perceived as critical by the hearing device user and can make improvements during a new fitting.

In a further embodiment of the present invention, a periodic recording of information is provided (so-called frequency triggering). The interval, i,e. the trigger frequency, is adjustable or is alterable automatically according to a pre-settable programmable pattern. By the variation of trigger frequency and of the recording length, the memory space used to record the information is reduced and the recording frequency can be adapted to the parameter being recorded. The data recorded over a longer time frame thereby gives an overall picture of the acoustic situation surrounding the hearing device user as well as the corresponding adjustment of the hearing device. By this information, the fitter can better adjust all adjustments of the hearing device and can particularly adjust to the hearing device user individually.

In a further embodiment of the present invention, the data recording takes place automatically, to be precise, for example, by certain characteristics of the acoustic surrounding (e.g. if a certain loudness, signal-to-noise ratio, etc. is reached or is exceeded, respectively) or by certain characteristics of the hearing device as automatic program switching or the occurrence of feedback. Therefore, one speaks of event-driven information recording. The actual trigger event is, according to the invention, freely selectable and can-differentiate from one hearing device user to another. If, for example, an automatic program switching is unpleasant for a hearing device user in a certain situation, the fitter can select exactly this program switching as trigger event. By the information recording at the occurrence of the event, the acoustic scenes are then recorded as, if need be, also the adjustments of the hearing device. The fitter can then provide a better adjustment of the hearing device after the analysis of the information so that the undesired automatic program switching in the hearing device does not occur anymore in the future.

For the developer of hearing devices, this procedure results in the additional advantage that the selection of the automatic operation condition can be checked and controlled under real acoustic surroundings.

For all of the described embodiments, a memory unit is provided either within the hearing device and/or it is provided an external memory in which the data or information, respectively, are recorded. In this connection, it is provided in a further embodiment of the present invention to partition the memory unit and/or the external memory into two or several sectors. In each sector, function-specific information or time-specific information are saved.

In a preferred embodiment, the memory unit and/or the external memory are partitioned into three sectors, the sectors being called single sector, append sector and overwrite sector.

In the single sector, information is recorded during the whole lifetime of a hearing device. The recording of, for example, production data as microphone type, receiver or loudspeaker type, etc. is meaningful. This sector of the memory unit or the external memory cannot be deleted.

In the append sector or continuous sector, the information being recorded is always appended to the last saved information. The memory unit or the external memory is thus filled from the front to the back successively with the newest information. By using this procedure, the fitting history of the hearing device can, for example, be recorded over a very long period. Also this sector cannot be deleted, but can be overwritten in contrast to the single sector.

Finally, the overwrite sector can be used for recording information, which occurs during operation. After the data recording has taken place for a certain period based on certain events, the data will not be used anymore after an interpretation has taken place. The fitter or the hearing device user frees the memory space again, for example, by a suitable manipulation at the remote control, at the hearing device or by a connected programming and reading unit. The sector can therefore be overwritten after the interpretation. So it is, for instance, feasible that the hearing device user wants to record a certain situation by data recording, but was not yet satisfied by the situations recorded so far, because the situations did not have the expected loudness or no feedback occurred. In this case, it is possible to delete the saved data again. Therewith, free memory space is again created for recording of new information.

The overwrite sector is in particular suitable for recording the gain, the signal feedback, program switching or for acoustic signals.

In a further embodiment, the overwrite sector is realized as circular buffer, in which the oldest data is overwritten by the youngest data. Accordingly, it is not necessary to delete this overwrite sector because the old data is deleted automatically within the bounds of the necessary memory space by the process of overwriting.

When recording information, the high current consumption must be observed, to be precise in particular when recording information in the memory unit 7 of the hearing device, because it quickly results in a very fast discharge of the batteries in the hearing device due to the limited energy available.

A write cycle normally lasts for approx. 4 to 8 ms and is therefore also called “burst”. During the write cycle, a high load of the battery occurs and therewith most often also hearable artifacts in the hearing device, because as a result of the write cycle a short-time voltage reduction is generated which results in an insufficient supply of the microphones, the amplifiers, etc. In order to prevent the generated artifacts, the following strategies are proposed in the boundaries of this invention.

It is expressly emphasized that the following measures are not only suitable for recording information in connection with the above explanations, but the following explanations have a general meaning while writing to a non-volatile memory in portable devices and can therefore be seen as independent invention:

A first variation is characterized in that, for the information recording, a favorable point in time must be awaited. Thereto, the information are first saved in a volatile memory and afterwards transferred to a non-volatile data memory, when the most favorable point in time is reached. A favorable point in time is e.g. reached then when the battery is only loaded slightly or when only little signal components must be generated at the output.

The second variation intends that, during the write cycle, the gain is increased in advance in such a way that a voltage drop due to the write cycle is compensated; therefore no recognizable change is observable at the output signal of the hearing device during a write cycle.

By a third variation, it is provided to use a kind of signal processing through which the hearable artifacts generated by the data recording are suppressed. The noise generated by a burst can be determined individually for each hearing device already in the developing phase and can be eliminated with the aid of a suitable signal processing program.

Finally, a fourth variation is proposed. It is concerned with the limitation of the frequency of write cycles. It has actually been recognized that the hearable artifacts are depending on the repeat rate of the write cycles. A maximum repeat rate is therefore set to a value at which just no hearable artifacts occur. This maximum admissible repeat rate is thereby in particular dependent on the hearing device type, the battery type, battery status and/or the memory type being used.

The access to the memory unit 7 to read and to program is done by suitable hardware over the connecting unit 10 shown in the figure, the possibility consisting in transferring the saved data in the memory of a (Personal Digital Assistant)-PDA or in a mobile telephone. In such a device, the transferred data can either be directly processed or can be transferred to a powerful calculator for further processing at a later point in time.

In a further embodiment, it is provided that the information is directly transferred to a powerful external calculator by bypassing the memory unit 7 in the hearing device in order to provide a visualization of the information on the external calculator, for example. Therewith, a good control possibility is particularly provided for the fitter.

The interpretation of information saved in the memory unit 7 during operation allows the adaptation of the hearing device. In a further embodiment, it is provided that the hearing device is automatically adjusted to certain situations. So, therefrom the possibility results to increase the gain in the hearing device after a certain operation time automatically. An important application thereof is related to those people that must get acquainted first to the wearing of a hearing device. A sudden improved acoustical perception due to a hearing device being used results in some irritation of the hearing device user as has experience shown, which irritation is reduced by a slow increase of the hearing device influence.

1. Method for recording information in a hearing device and/or in a recording unit at least temporally operationally connected to the hearing device, the method consisting in that a point in time of the recording and/or a recording frequency as well as the information to be recorded, as data and/or parameters and/or adjustments of the hearing device are adjusted freely or are programmable, respectively.

2. Method according to claim 1, wherein the point in time for the recording of information is triggered or changed either manually or event-driven.

3. Method according to claim 1 or 2, wherein the information is processed before the recording and wherein only the processed information is being recorded.

4. Method according to one of the preceding claims, wherein the information is recorded in a memory unit (7) which is located in the hearing device, a recording of information being carried out only then if one or several of the following conditions are met:
a battery unit supplying energy lo the hearing device has an output voltage that lies above a predefined value;
there exist no surround sound to be processed by the hearing device;
a mean level of surround noise is higher as a predefined level value;
the amount of information to be recorded is limited to a predefined value, for example to 128 bytes.

5. Method according to one of the claims 1 to 3, wherein the information is recorded in a memory unit (7) which is located in the hearing device, a reduction of a supply voltage due to the recording process being compensated.

6. Method according to one of the claims 1 to 3, wherein noise signal generated by the recording process are being eliminated by a filter.

7. Method according to one of the claims 1 to 3, wherein the recording of information occurs in data packets, a repeat rate for the recording of the data packets not exceeding a predefined repeat rate.

8. Method according to claim 7, wherein the predefined repeat rate corresponds to a maximum value at which hearable artifacts just do not occur by the recording process.

9. Method according to one of the preceding claims, wherein the information is recorded in at least one of two sectors in the memory unit (7).

10. Method according to claim 9, wherein the information is recorded in at least one of three sectors, information being recorded in a first sector is neither deleted and nor appended, information being recorded in a second sector is not deleted, new information being recorded in the second sector being appended, and information having been recorded in a third sector is deleted.

11. Method according to claim 9, wherein the information is recorded in at least one of three sectors, information being recorded in a first sector is neither deleted and nor appended, information being recorded in a second sector is saved in a circular buffer in which new information is recorded at a location of the oldest information stored in the circular buffer, and information having been recorded in a third sector is deleted.

12. Method according to one of the preceding claims, wherein a date and/or time unit is provided in the hearing device which date and/or time unit is being synchronized with an external synchronization unit.

13. Method according to claim 12, wherein one or a combination of the following equipment is being used as synchronization unit:
remote control;
computer;
mobile telephone;
PDA;
atomic clock.

14. Method according to claim 12 or 13, wherein an acoustic signal and/or speech synthesized information is being generated in the hearing device based on previously set time or date information.

15. Hearing device comprising
a signal processing unit (3),
a control unit (6),
a memory unit (7),
at least one microphone (1),
a loudspeaker unit (5),
the at least one microphone (1) and the loudspeaker unit (5) being operationally connected to the signal processing unit (3) which on its part being operationally connected to the memory unit (7) over the control unit (6), wherein a point in time for the recording and/or a recording frequency as well as also the information to be recorded, as data and/or parameters and/or adjustments of the hearing device, are freely adjustable or programmable, respectively.

16. Hearing device according to claim 14, wherein the information are savable in the memory unit (7).

17. Hearing device according to claim 15, wherein the information is savable outside.

18. Hearing device according to claim 15, wherein the memory unit (7) is partitioned into at least two sectors.

19. Hearing device according to claim 18, wherein the information is recordable in at least one of three sectors, information being recordable in a first sector is not changeable, information being recordable in a second sector is not deleted, new information being recordable in the second sector is appended, and information being recordable in a third sector is deleted.

20. Hearing device according to claim 18, wherein the information is recordable in at least one of three sectors, information being recordable in a first sector is neither deleted and nor appended, information being recordable in a second sector is savable in a circular buffer in which new information is recordable at a location of the oldest information stored in the circular buffer, and information being recordable in a third sector is deleted.

21. Hearing device according to one of the claims 15 to 20, wherein a date and/or time unit is provided in the hearing device which date and/or time unit is synchronizable with an external synchronization unit.

22. Hearing device according to claim 21, wherein one or a combination of the following equipment is used as synchronization unit:
remote control;
computer;
mobile telephone;
PDA;
atomic clock.

23. Hearing device according to claim 21 or 22, wherein an acoustic signal and/or speech synthesized information is generated in the hearing device based on previously set time or date information.

24. Hearing device according to one of claims 21 to 23, wherein preset actions are generated based on one or several of the following factors:
preset time of day;
preset date;
working day or preset working day, respectively;
holyday.

25. Binaural hearing device with at least two hearing device parts, at least one of the at least two hearing device parts are realized according to one of the claims 15 to 24.
